(19) United States
(12) Patent Application Publication
(10) Pub. No.: US 2016/0169481 A1
(43) Pub. Date: Jun. 16, 2016

(54) Illumination Systems with Co-Formed Optical Element

(71) Applicant: Amerillum LLC, Oceanside, CA (US)

(72) Inventors: Justin L. Horvath, Oceanside, CA (US); Ron Lancial, Oceanside, CA (US)

(21) Appl. No.: 14/848,248

(22) Filed: Sep. 8, 2015

(51) Int. Cl. F21V 13/04; F21V 7/00; F21V 7/22; F21V 17/10; F21V 23/00; F21V 5/04; F21V 17/08

(52) U.S. Cl. CPC F21V 13/04; F21V 5/04; F21V 7/005; F21V 17/08; F21V 17/102; F21V 23/009; F21V 7/22; F21Y 2103/003

(57) ABSTRACT

An illumination system includes a housing elongated along a first direction, a substrate supported inside the housing and extending along the first direction, a plurality of light emitting diodes (LEDs) distributed along and supported by the substrate inside the housing; and a co-formed optical element extending along the first direction, the co-formed optical element including an optical coupler made from a first material and a lens made from a second, different material, where the optical coupler and the lens are integrally co-formed as a single piece such that the lens joins seamlessly with the optical coupler.

### FIELD OF THE DISCLOSURE

Illumination systems described herein include a co-formed optical element which has an optical coupler made from a reflective material and a lens made from a transmissive, diffusive material, where the optical coupler and the lens are integrally co-formed as a single piece such that the lens joins seamlessly with the optical coupler.

### BACKGROUND

Many types of electric light sources, such as, incandescent lamps, fluorescent lamps, compact fluorescent lamps (CFL), cold cathode fluorescent lamps (CCFL), high-intensity discharge lamps have been used for general illumination purposes. The foregoing types of electric light sources are gradually being replaced in many general illumination applications by solid state light sources, e.g., light-emitting diodes (LEDs).

Development of LED-based illumination systems, e.g., LED-based pendant lighting fixtures or LED-based troffer lighting fixtures, has focused on ways to output as much of the light emitted by the LEDs as possible into the ambient while providing at least some directionality of propagation to the output light to make the latter safe and useful for general illumination purposes. For example, controlling glare of LED-based illumination systems and uniformity of illumination provided by LED-based illumination systems can be very challenging because the LEDs are quasi-point sources that emit very bright light. Optical elements, such as reflective plates and/or transmissive plates, are placed inside the LED-based illumination systems, in proximity to the LEDs, to redirect and mix the light emitted by the quasi-point source LEDs, so glare can be reduced and uniform illumination can be provided by the LED-based illumination systems.

### SUMMARY

According to an aspect of the disclosed technologies, an illumination system includes a housing elongated along a first direction, a substrate supported inside the housing and extending along the first direction, a plurality of light emitting diodes (LEDs) distributed along and supported by the substrate inside the housing, and a co-formed optical element extending along the first direction. The co-formed optical element extends along the first direction and includes an optical coupler including a first material. The optical coupler is optically coupled with the LEDs to receive light emitted by the LEDs and is configured to reflect the emitted light as reflected light with a divergence smaller than a divergence of the emitted light, at least in a cross-section orthogonal to the first direction. The co-formed optical element further includes a lens including a second material, the second material being different from the first material, the lens being configured and arranged to diffuse the reflected light by transmitting the light through the lens to an ambient environment as output light. The optical coupler and the lens are integrally co-formed as a single piece such that the lens joins seamlessly with the optical coupler, where an optical axis of the co-formed optical element is orthogonal to the first direction, and a joint where the optical coupler and the lens join together is in a plane orthogonal to the optical axis. Additionally, the co-formed optical element includes attachment elements that cause the co-formed optical element to attach itself inside the housing through friction with the housing caused by compression of the attachment elements.

The foregoing and other embodiments can each optionally include one or more of the following features, alone or in combination. In some implementations, the one or more attachment elements can be integrally co-formed with the optical coupler. In some such implementations, the one or more attachment elements include the same first material as the optical coupler. In some implementations, the first material from which the optical coupler is formed can be a first acrylic, and the second material from which the lens is formed can be a second acrylic.

In some implementations, a cross-section of side surfaces of the optical coupler in a plane orthogonal to the first direction can include one or more arcs of one or more parabolas, hyperbolas or circles. In some implementations, a cross-section of an output surface of the lens can be flat. In some implementations, a cross-section of an output surface of the lens can be convex. In some implementations, a cross-section of an output surface of the lens can be concave.

In some implementations, an opening of the optical coupler can form an opening plane orthogonal to an optical axis of the co-formed optical element, and a relative arrangement of the substrate to the opening can be such that a surface of the substrate that supports the LEDs coincides with the opening plane or is displaced from the opening plane towards the lens. In some implementations, the illumination system further includes a power supply coupled with the LEDs configured to power the LEDs. The power supply can be supported inside the housing. In some implementations, the LEDs can be configured to emit white light.

According to another aspect of the disclosed technologies, an illumination system includes a co-formed optical element for a light fixture includes an optical coupler including a first material, the optical coupler configured and arranged to reflect light from a light source; and a lens including a second material, the second material being different from the first material, the lens being configured and arranged to diffuse the light, which is reflected by the optical coupler from the light source, by transmitting the light through the lens. Here, the optical coupler and the lens are integrally co-formed as a single piece such that the lens joins seamlessly with the optical coupler.

The foregoing and other embodiments can each optionally include one or more of the following features, alone or in combination. In some implementations, the first material from which the optical coupler is formed can be a first acrylic, and the second material from which the lens is formed can be a second acrylic. In some implementations, the optical coupler and the lens can be coextruded materials.

In some implementations, the light source includes a light emitting diode (LED), and the optical coupler can be shaped to reflect the light emitted by the LED as reflected light, such that a divergence of the reflected light is smaller than a divergence of the emitted light. In some cases, a surface of the optical coupler can be configured to reflect the emitted light through specular reflection. In some cases, a surface of the optical coupler can include a microstructure that reflects the emitted light through diffuse reflection.

In some implementations, an area of a joint where the optical coupler and the lens join together can be a fraction of each of an area of either of side surfaces of the optical coupler and an area of an output surface of the lens. Further, the co-formed optical element can be elongated along a first direction orthogonal to an optical axis of the co-formed optical element. In some cases, a cross-section of side surfaces of the optical coupler in a plane orthogonal to the first direction can include one or more arcs of one or more parabolas, hyperbolas or circles. In some cases, a cross-section of an output surface of the lens can be flat. In some cases, a cross-section of an output surface of the lens can be convex. In some cases, a cross-section of an output surface of the lens can be concave.

In some implementations, an illumination device can include the foregoing co-formed optical element; a substrate elongated along the first direction; and a plurality of LEDs distributed along and supported by the substrate. Here, the optical coupler of the co-formed optical element is optically coupled with the plurality of LEDs. During operation of the illumination device, the optical coupler reflects light emitted by the plurality of LEDs as reflected light with a divergence smaller than a divergence of the emitted light, at least in a cross-section orthogonal to the first direction, and the lens transmits the reflected light to an ambient environment as output light.

In some implementations of the illumination device, an opening of the optical coupler can forms an opening plane orthogonal to the optical axis of the co-formed optical element, and a relative arrangement of the substrate to the opening can be such that the opening plane coincides with a surface of the substrate that supports the LEDs. In some implementations of the illumination device, the LEDs can be configured to emit white light. In some implementations of the illumination device, the LEDs can be packaged LEDs. Additionally, the illumination device includes a power supply configured to provide electrical current to the plurality of LEDs.

In some implementations, an illumination system can include the foregoing illumination device and a housing configured and arranged to support the illumination device. In some implementations of the illumination system, the optical element can include one or more attachment elements that cause the co-formed optical element to attach itself inside the housing, and the housing includes a substrate mount configured to support the substrate. Here, the co-formed optical element can attach itself to the housing through friction with the housing caused by compression of the attachment elements. Further, the one or more attachment elements can be integrally co-formed with the optical coupler. Furthermore, the one or more attachment elements can include the same first material as the optical coupler. In some implementations of the illumination system, the housing can include a power supply mount to support the power supply.

Particular aspects of the disclosed technologies can be implemented so as to realize one or more of the following potential advantages. For example, using a co-formed optical element including an optical coupler and a lens to design an illumination system as opposed to conventionally using an optical coupler formed from separate reflectors and placed in proximity to a lens can potentially provide tighter tolerance on the shape and location of the optical coupler portion of the system, in the following manner. While extrusion tolerances are much easier to hold when manufacturing parts of the small sizes needed in LED optical design, the separate reflectors are conventionally fabricated from sheet metal and bent into the desired shape. The latter process has inherent tolerances, which at the small level desired when dealing with LED optics can have significant impact on the performance and consistency of the illumination system. Moreover, the disclosed technologies increase flexibility for difficult illumination system builds, because the co-formed optical element can be simply mitered to a patterned or shaped fixture, while the optical coupler formed from separate sheet metal reflectors and placed in proximity to the lens is joined to the fixture in a more complicated manner.

As another example, using a co-formed optical element including an optical coupler and a lens to design an illumination system as opposed to conventionally using an optical coupler formed from separate reflectors and placed in proximity to a lens can potentially provide higher luminous efficacy because tighter tolerances on shape and location of the optical coupler that is co-formed with the lens results in efficiencies that are about 27% greater than for the combination of the separate sheet metal reflectors and the lens. For instance, the separate reflectors of the optical coupler and the lens of the conventional combination are generally held in place by some sort of clip or adhesive that may create a gap between the separate reflectors and the lens which potentially can result in loss of light inside the illumination system, while light losses of this nature are eliminated when the disclosed co-formed optical element is used in illumination systems.

As yet another example, using a co-formed optical element including an optical coupler and a lens in an illumination system as opposed to conventionally using an optical coupler formed from separate reflectors and placed in proximity to a lens can potentially improve uniformity of the illumination issued by the illumination system because light redirected by the optical coupler that is co-formed with the lens is optimized in direction to exit through the entire width of the lens. Instead of a subtle hot spot being present in the center of the lens and fading toward the sides, as can occur when the lens is conventionally combined with separate reflectors, there is a desirable uniformity across the width of the lens when the disclosed co-formed optical element is used in the illumination system.

As yet another example, using a co-formed optical element including an optical coupler and a lens in an illumination system as opposed to conventionally using an optical coupler formed from separate reflectors placed in proximity to a lens can potentially lower labor cost because installation of one unit (the co-formed optical element) instead of three (the lens and two separate reflectors) may significantly reduce labor cost for this portion of the illumination system build. Additionally, the disclosed technologies can potentially lower materials cost relative to the conventional technologies because while a cost of the disclosed co-formed optical element may be higher than the cost of the lens and separate reflectors, when the cost of screws or other fasteners is added along with extra costs of assembling the lens and separate reflectors using the fasteners, the installed cost of the optical coupler formed from separate reflectors placed in proximity to the lens is higher than the installed cost of the disclosed co-formed optical element.

Details of one or more implementations of the disclosed technologies are set forth in the accompanying drawings and the description below. Other features, aspects, descriptions and potential advantages will become apparent from the description, the drawings and the claims.

### BRIEF DESCRIPTION OF THE DRAWINGS

FIG. 1 shows an example of an illumination system including an illumination device that uses a co-formed optical element.

FIG. 2 shows an example of an illumination device that uses a co-formed optical element.

FIGS. 3A-3B and 4A-4B shows aspects of a co-formed optical element.

FIG. 5 shows light intensity distributions for light output by an illumination device that uses a co-formed optical element.

Certain illustrative aspects of the illumination systems, illumination devices, and co-formed optical elements according to the disclosed technologies are described herein in connection with the following description and the accompanying figures. These aspects are, however, indicative of but a few of the various ways in which the principles of the disclosed technologies may be employed and the disclosed technologies are intended to include all such aspects and their equivalents. Other advantages and novel features of the disclosed technologies may become apparent from the following detailed description when considered in conjunction with the figures.

### DETAILED DESCRIPTION

Illumination systems described herein include a co-formed optical element, where the co-formed optical element has an optical coupler made from a reflective material and a lens made from a transmissive, diffusive material, such that the optical coupler and the lens are integrally co-formed as a single piece such that the lens joins seamlessly with the optical coupler. Such an illumination system can be included in an illumination fixture, for instance, as described below.

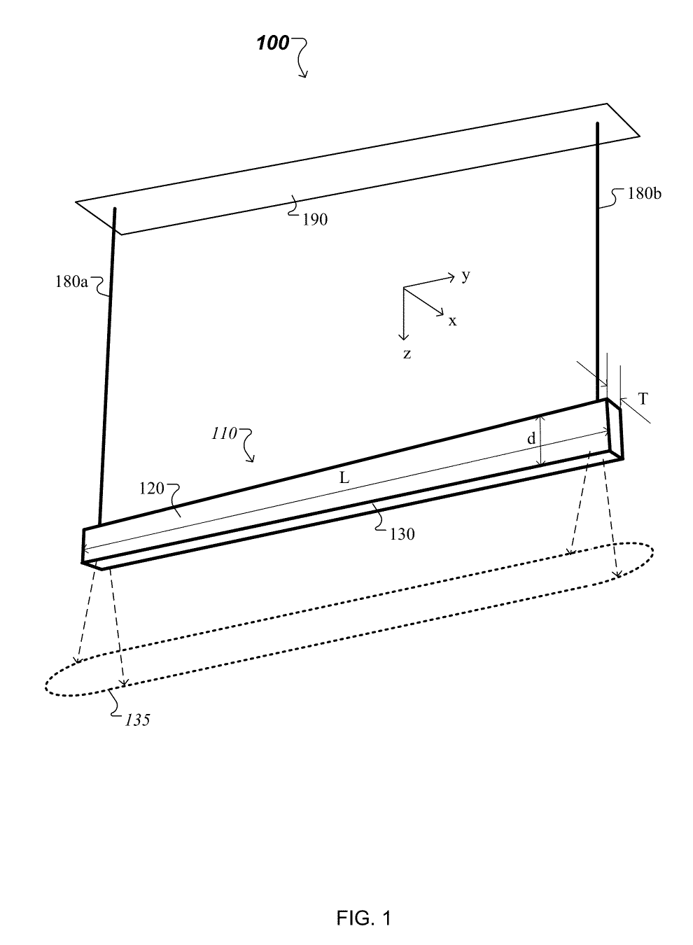

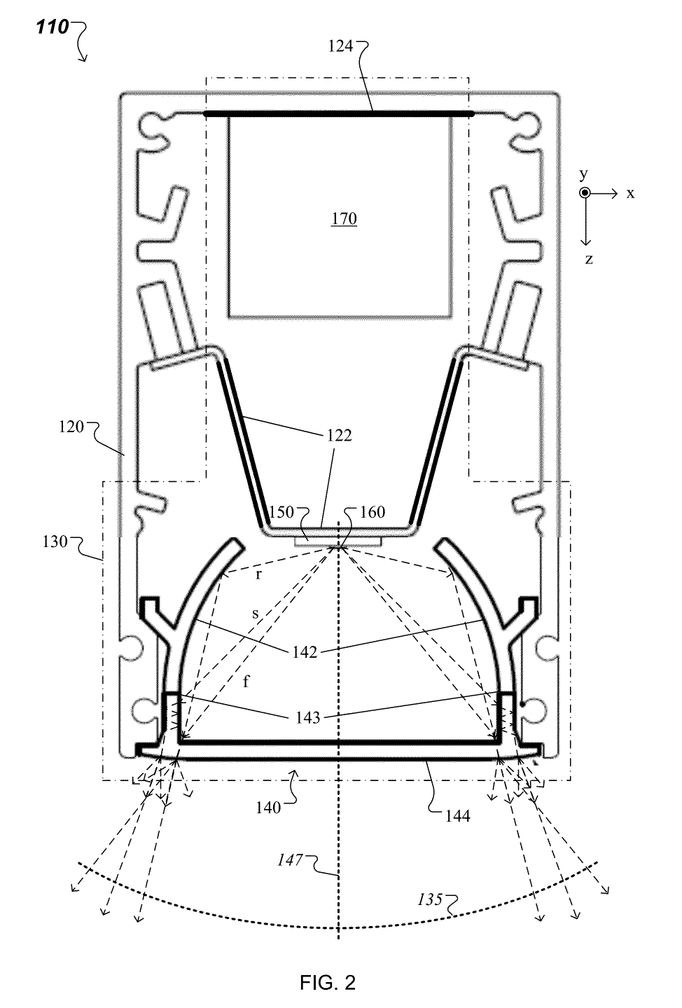

FIG. 1 shows an example of an illumination fixture 100 including an illumination system 110 and cables 180a, 180b. Here, the illumination system 110 is suspended from a ceiling 190 by the cables 180a, 180b. The illumination system 110 includes a housing 120 and an illumination device 130. As described below in this specification in conjunction with FIG. 2, the illumination device 130 includes a co-formed optical element. Referring again to the example illustrated in FIG. 1, the housing 120 of the illumination system 110 is elongated along the y-axis over a length “L”, has a thickness “T” along the x-axis and a depth “d” along the z-axis. The illumination system 110 outputs, to an ambient environment (e.g., towards a target surface—not shown in FIG. 1), output light in an output angular range 135. Here, the prevalent propagation direction of the output light is along the z-axis.

FIG. 2 shows a cross-section in the x-z plane of an example implementation of the illumination system 110. Here, the illumination system 110 includes the housing 120 and the illumination device 130. The illumination device 130 includes a substrate 150, one or more LEDs 160, a co-formed optical element 140 and a power supply 170. In this example, a substrate mount 122 of the housing 120 supports the substrate 150, and a power supply mount 124 of the housing supports the power supply 170.

The co-formed optical element 140 includes an optical coupler 142 and a lens 144, where the optical coupler and the lens are integrally co-formed as a single piece such that the lens joins seamlessly with the optical coupler at joint 143. Here, the optical coupler 142 includes a first material, and the lens 144 includes a second material different from the first material. Moreover, the optical coupler 142 is configured and arranged to reflect light from the LEDs 160, and the lens 144 is configured and arranged to diffuse the light, which is reflected by the optical coupler from the LEDs, by transmitting the light through the lens.

In some implementations, a plurality of LEDs 160 are supported by and distributed on the substrate 150 along the y-axis (perpendicular to the page) over the length L of the substrate. The number of LEDs 160 on the substrate 150 generally depend on the length L, along the y-axis, where more LEDs are used for longer illumination systems 110. In some implementations, the plurality of LEDs 160 can include between 10 and 100 LEDs (e.g., about 20 LEDs, about 40 LEDs, about 60 LEDs, about 80 LEDs). Generally, the density of LEDs 160 (e.g., number of LEDs per unit length) also depends on the nominal power of the LEDs and illuminance desired from the illumination systems 110. For example, relatively high density of LEDs 160 can be used in applications where high illuminance is desired or where low power LEDs are used. In some implementations, the illumination system 110 has an LED density along its length of 0.1 LED per centimeter or more (e.g., 0.2 per centimeter or more, 0.5 per centimeter or more, 0.8 per centimeter or more, 1 per centimeter or more, 1.7 per centimeter or more, 2 per centimeter or more). The density of LEDs 160 may also be based on a desired amount of mixing of light emitted by the plurality of LEDs. In some implementations, the LEDs 160 can be evenly spaced along the length, L, of the illumination system 110.

In some implementations, the LEDs 160 are configured to emit white light. For example, each of the LEDs 160 can include an LED die (or chip) that emits blue pump light and also be covered with a layer of phosphor that, at least partially, converts the blue pump light into “white” light. In this manner, the white light emitted by the LEDs 160 has a broad spectrum that can extend over a wavelength range from blue, through green, to red. In some implementations, the illumination system 110 can include one or multiple types of LEDs 160, for example one or more subsets of LEDs in which each subset can have a different emission spectrum. The LEDs 160 are powered, during operation of the illumination system 100, by the power supply 170.

As shown using dashed rays in FIG. 2, a portion of light emitted by the LEDs 160 propagates directly to the lens 144 (without undergoing reflection off the optical coupler 142). This portion of the emitted light is represented by forward rays “f” and side rays “s”. A remaining portion of the light emitted by the LEDs is reflected by the optical coupler 142 towards the lens 144. This remaining portion of the emitted light is represented by reflected rays “r”. In this manner, a divergence of the light that impinges on the lens 144 is smaller, in the x-z plane, than a divergence of the emitted light. Light that impinges on the lens 144 diffusely transmits through the lens into an ambient environment as output light with an angular range 135. An optical axis 147 of the co-formed optical element 140 in the x-z plane represents a prevalent propagation direction of the light emitted by the one or more LEDs 160 and received by the co-formed optical element 140, as well as of the light output by the co-formed optical element. In the example illustrated in FIG. 2, the optical axis 147 is parallel to the z-axis and orthogonal to the substrate 150. Here, the LEDs 160 are placed at an intersection of the optical axis 147 and the substrate 150.

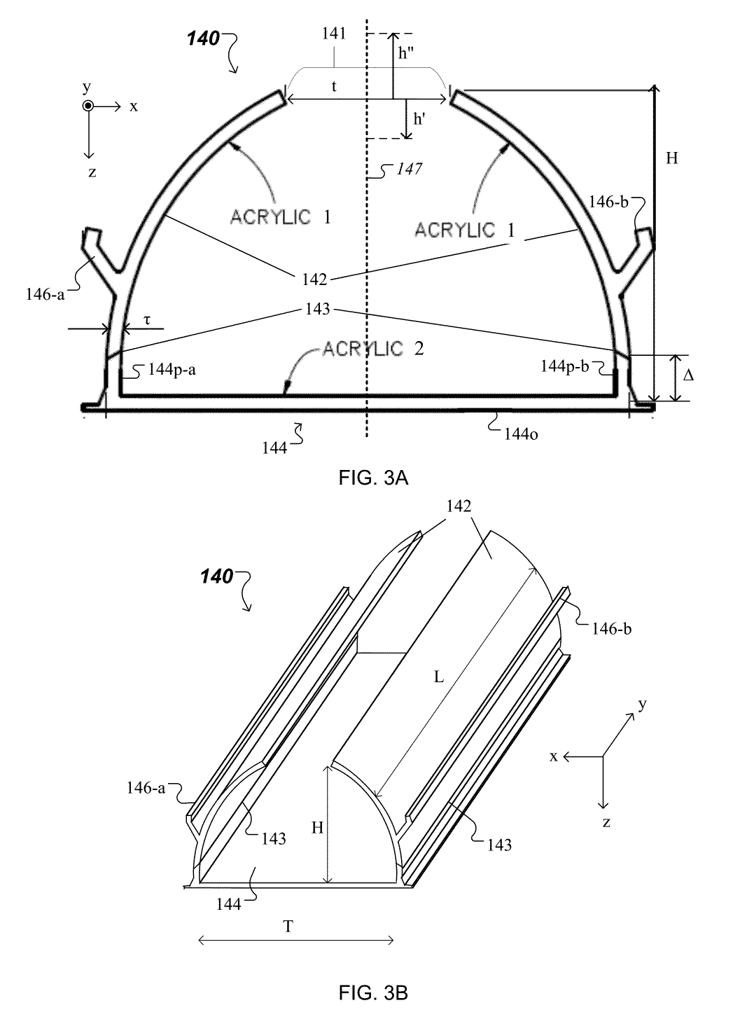

FIG. 3A shows a cross-section in the x-z plane of the co-formed optical element 140 of the illumination device 130, and FIG. 3B shows a perspective view of the same. The optical coupler 142 of the co-formed optical element 140 has an opening 141 that is centered on the optical axis 147 of the co-formed optical element. Here, the optical axis 147 is oriented along the z-axis. A cross-section of side surfaces of the optical coupler 142 in the x-z plane can include one or more arcs of one or more of a parabola, a hyperbola or a circle, for instance. A profile of the side surfaces of the optical coupler 132 in the x-z plane determines an optical power of the optical coupler. Moreover, in the example shown in FIG. 3B, the side surfaces of the optical coupler 142 have uniform x-z cross-sections along the y-axis.

The lens 144 of the co-formed optical element 140 includes a portion 144o that is orthogonal to the optical axis 147 (also referred to as lens output surface 144o) and portions 144p-a, 144p-b that are substantially parallel to the optical axis (also referred to as lens side surfaces 144p-a, 144p-b). In this manner, the joint 143 is formed between the optical coupler 142 and the lens side surfaces 144p-a, 144p-b.

In the example shown in FIGS. 3A-3B, the lens output surface 144o has a flat profile in the x-z cross-section. As the flat lens output surface 144o does not exhibit optical power, divergence of an angular range 135 (shown in FIG. 2) of the light transmitted there through and output to the ambient environment by the co-formed optical element 140 is determined solely by the optical power of the optical coupler 142.

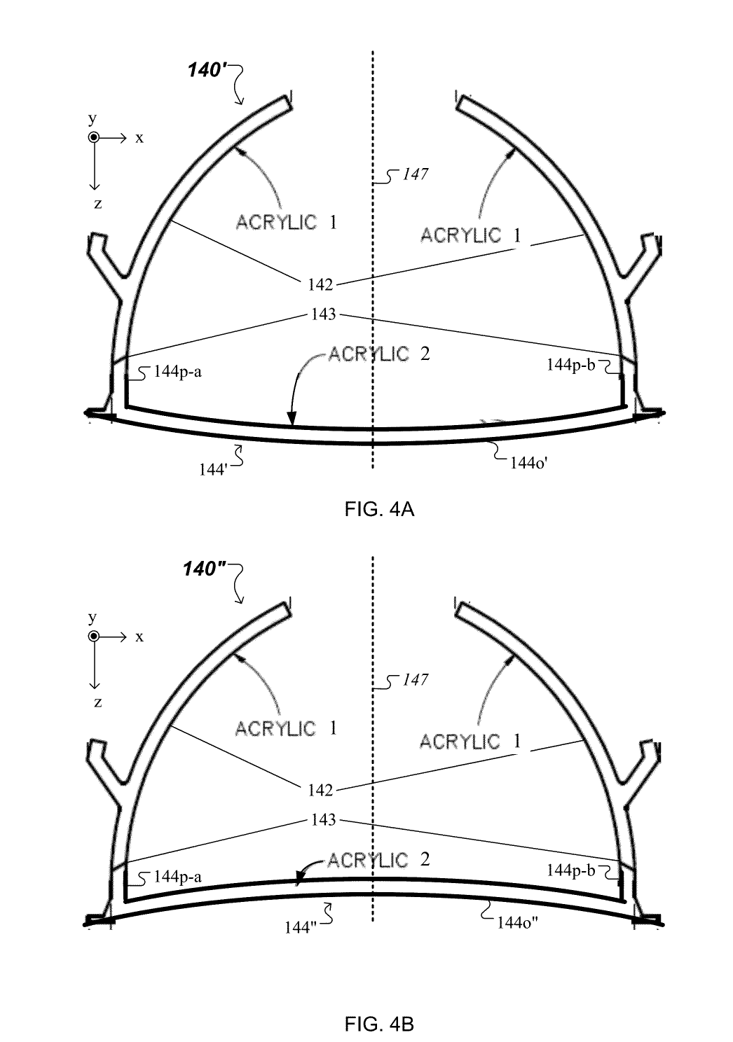

FIG. 4A shows an implementation 140′ of the co-formed optical element which includes the optical coupler 142 and an implementation 144′ of the lens. The lens 144′ of the co-formed optical element 140′ includes a lens output surface 144o′ that has a curved profile in the x-z cross-section. In this example, the curved profile of the lens output surface 144o′ has positive curvature and, hence, the lens output surface 144o′ is convex. As the convex lens output surface 144o′ exhibits a finite optical power (given in terms of its curvature), the divergence of the angular range 135 of the light transmitted through the convex lens output surface 144o′ and output to the ambient environment by the co-formed optical element 140′ is determined by a combination of the optical power of the optical coupler 142 and the optical power of the convex lens output surface 144o′.

FIG. 4B shows an implementation 140″ of the co-formed optical element which includes the optical coupler 142 and an implementation 144″ of the lens. The lens 144″ of the co-formed optical element 140″ includes a lens output surface 144o″ that has another curved profile in the x-z cross-section. In this example, the other curved profile of the lens output surface 144o″ has negative curvature and, hence, the lens output surface 144o″ is concave. As the concave lens output surface 144o″ exhibits a finite optical power (given in terms of its curvature), the divergence of the angular range 135 of the light transmitted through the concave lens output surface 144o″ and output to the ambient environment by the co-formed optical element 140″ is determined by another combination of the optical power of the optical coupler 142 and the optical power of the concave lens output surface 144o″.

Referring now to all of FIGS. 3A-3B and 4A-4B, in some implementations, a thickness τ of the optical coupler 142 and the lens 144 is constant everywhere in the x-z cross-section. In other implementations, a thickness of the optical coupler 142 can be equal to τ adjacent to the joint 143 and larger than τ away from the joint. Additionally or alternatively, a thickness of the lens side surfaces 144p-a, 144p-b can be equal to τ, while a thickness of the lens output surface 144o is smaller than τ.

In the examples illustrated in FIGS. 3A-3B and 4A-4B, a length L, along the y-axis, of the co-formed optical element 140 can have a value in the range of about 1-400 cm, e.g., about 10, 20, 30, 500, 100, 200, 300, 365 cm. A width T, along the x-axis, of the lens output surface 144o can have a value in the range of about 50-150 mm, e.g., about 60, 70, 80, 90, 100, 110, 120 or 125 mm. In some implementations, the opening 141 is spaced apart from the lens output surface 144o by a depth H along the optical axis 147 that has about the same value as a value of the width T. In this example, the opening 141 has a width “t” along a direction orthogonal to the optical axis 147 (here, in the x-y plane.) The width t of the opening 141 is determined by a width (here, along the x-axis) of a substrate 150 that supports a plurality of LEDs 160 distributed along the y-axis. For example, the width t of the opening 141 can have a value in the range of about 25-75 mm, e.g., about 20, 40 or 60 mm.

Note that an area of the joint 143 where the optical coupler 142 and the lens 144 join together is a fraction of an area of either of side surfaces of the optical coupler that is smaller than τ/H. Further, the area of the joint 143 is another fraction of an area of the lens output surface 144o (or 144′ or 144o″) that is of order τ/T.

Moreover, the joint 143 is formed at a distance Δ, along the optical axis 147, from the lens output surface 144o. In this example, the distance Δ is defined as a distance from a first plane fit through the lens output surface 144o to a second plane fit through the joint 143 and parallel to the first plane, so Δ<H. The distance Δ is configured to have a value of about 20%, 10%, 5% of a value of the depth H to allow for a portion of the light emitted by the LEDs 160 (represented in FIG. 2 by the side rays “s”) to directly reach the lens side surfaces 144p-a, 144p-b (without reflection off the optical coupler 142). This portion of the emitted light impinges on the lens side surfaces 144p-a, 144p-b and is guided through these lens side surfaces, to reach the lens output surface 144o at the intersections of the lens side surfaces with the lens output surface, prior to exiting the lens output surface as part of the light output by the co-formed optical element 140. In this manner, during operation of the illumination device 130 that includes the co-formed optical element 140, the lens output surface 144o beneficially appears to be uniformly lit (along a direction orthogonal to the optical axis 147), over its entire width T, when the illumination device is being viewed by an observer located downstream from the illumination device. If the lens 144 had no lens side surfaces 144p-a, 144p-b, which corresponds to a case in which the joint 143 were formed between the optical coupler 142 and the lens output surface 144o (Δ→0), then a subtle hot spot would be formed in the center of the lens output surface, fading toward the sides, causing undesirable non-uniformity across the width T of the lens output surface.

In some implementations, a surface of the substrate 150 that supports the plurality of LEDs 160 can be placed in the plane of the opening 141 or can be biased towards the lens output surface 144o relative to the plane of the opening, for instance by a distance h′. Here, the distance h′ can have a value of up to about 5 mm, e.g., h′ can be about 1, 2, 3 or 4 mm. In other implementations, the surface of the substrate 150 that supports the plurality of LEDs 160 can be biased away from the lens output surface 144o relative to the plane of the opening 141, for instance by a distance h″. In this case, the opening 141 is referred to as the input aperture 141 of the co-formed optical element 140. In order for the light emitted by the LEDs 160 to be optimally captured through the input aperture 141, the distance h″ satisfies the following condition: h″≦H(t/(T−t)).

Moreover, the optical coupler 142 includes a first material, and the lens 144′ includes a second material different from the first material. A function of the optical coupler 142 is to reflect light from the LEDs 160, and a function of the lens 144 is to diffuse the light, which is reflected by the optical coupler, by transmitting the light through the lens. As such, the optical coupler 142 and the lens 144 of the co-formed optical element 140 are integrally co-formed as a single piece, such that the lens joins seamlessly with the optical coupler at joint 143, in the following manner.

The optical coupler 142 is co-formed from a first material that reflects light received from a light source (here from the LEDs 160). The first material can be a reflective acrylic, such as a mix of about 75% virgin acrylic (RP-Acry/LF-CV) and about 25% opaque frost acrylic (RP-ACRIM/FRST-PV) (with a color fraction of RC-WK002/LD10-C), or a reflective polycarbonate, such as Bayer Makrolon™ 6265X or FR6901 or Sabic™ BFL4000 or BFL2000. In some implementations, the first material can be configured to diffusively reflect light impinging on a surface thereof, where the first material has a surface texture including one or more of the following microstructures: diamond shaped prisms, square shaped prisms, fish eye prisms, cracked ice, crepe/stipple finish, and the like. In other implementations, the first material can be configured to specularly reflect light impinging on a surface thereof, where the first material has a smooth surface finish. In either of the foregoing implementations, a reflection coefficient of the first material can be in the range of about 90-99%.

The lens 144 is co-formed from a second material that diffuses light received inside the co-formed optical element 140 from the optical coupler 142, by transmitting the light through the lens to the ambient environment, outside the co-formed optical element. The second material can be a diffusive and transmissive acrylic, also referred to as a translucent acrylic, such as a mix of about 75% virgin acrylic (RP-Acry/LF-CV) and about 25% impact modified translucent acrylic (RP-ACRIM-CV) (with a color fraction of RC-WK019-C) or a diffusive and transmissive polycarbonate, also referred to as a translucent polycarbonate, such as Makrolon Lumen XT™, Acrylite LED™, Acrylite Endlighten T™, or LuciteLux™. The second material is configured to diffusively transmit light impinging thereon, where a surface or bulk of the second material has one or more of the following microstructures: diamond shaped prisms, square shaped prisms, fish eye prisms, cracked ice, crepe/stipple finish, and the like. A transmissivity of the second material can be in the range of about 90-99% for a lens thickness of 0.060″ or in the range of 80-90% for a lens thickness of 0.118″.

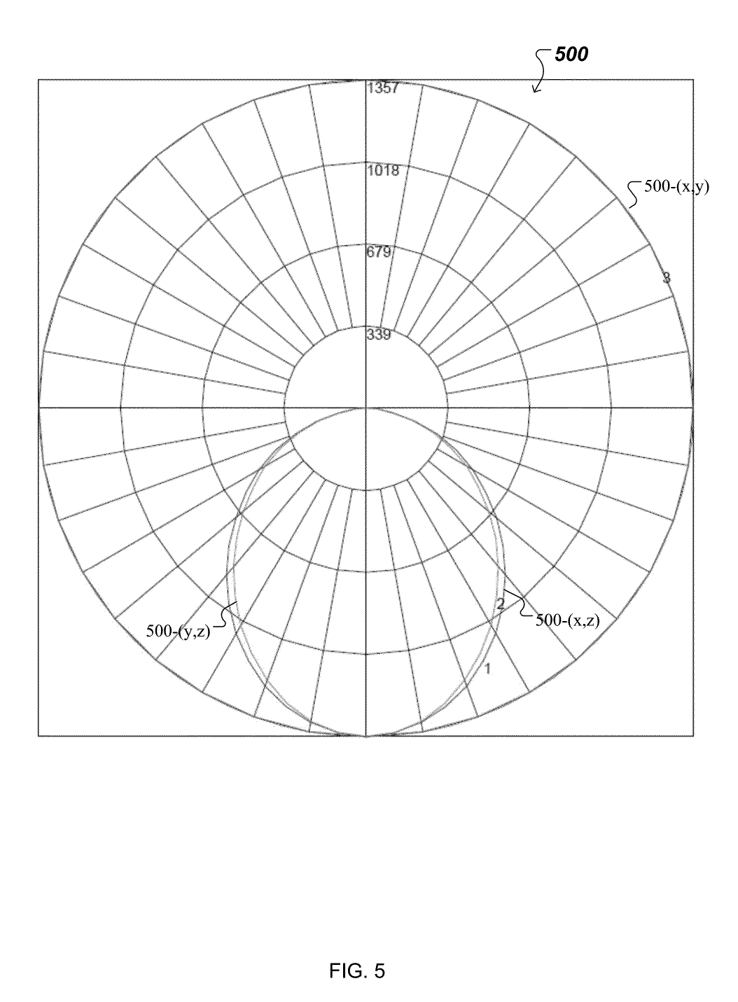

As a consequence of the diffusive properties of at least the second material included in the lens 144, various intensity distributions of light output when operating the illumination device 130, which includes the co-formed optical element 140, have Lambertian profiles. FIG. 5 shows a polar plot 500 including an intensity distribution 500-(x,z) of light output by the co-formed optical element 140 in the x-z vertical plane, an intensity distribution 500-(y,z) of light output by the co-formed optical element in the y-z vertical plane, and an intensity distribution 500-(x,y) of light output by the co-formed optical element in the x-y horizontal plane. The intensity distributions 500-(x,z) and 500-(y,z) shown in polar plot 500 are Lambertian distributions that are specific to diffuse light, thus confirming that the light provided by the optical coupler 142 diffusely transmits through the lens 144 prior to exiting the co-formed optical element 140.

Referring again to FIGS. 2, 3A-3B and 4A-4B, the co-formed optical element 140 further includes attachment elements 146a, 146b that are shaped and arranged to cause the co-formed optical element 140 to attach itself inside the housing 120 of the illumination system 110. For example, the co-formed optical element 140 attaches itself to the housing 120 through friction with the housing caused by compression of the attachment elements 146a, 146b. In these example implementations, the attachment elements 146a, 146b are integrally co-formed with the optical coupler 142. In some such cases, the attachment elements 146a, 146b include the same first material as the optical coupler 142. In other such cases, the attachment elements 146a, 146b include a material different from the first material included in the optical coupler 142.

In general, co-forming is a single-step process of making an optical component from a plurality of dissimilar materials that have different properties (e.g., different optical properties). Examples of co-forming are co-extruding and injection molding, for instance. When the co-formed optical element 140 is co-extruded, the optical coupler 142 and the lens 144 are co-extruded materials, the former having reflective properties and the latter having transmissive properties. In some implementations, each of the optical coupler 142 and the lens 144 has diffusive properties. When the co-formed optical element 140 is injection molded, the optical coupler 142 and the lens 144 are injection molded materials.

Co-extrusion used to co-form the co-formed optical element 140 can be achieved by performing a first extrusion of the optical coupler 142, followed by a second extrusion of the lens 144. As such, a first extruder and a second extruder can be configured to concurrently melt a first material in a first extruder and a second material in a second extruder, and deliver a steady volumetric throughput of a melt of the first material and a melt of the second material to a single extrusion head (die) which is configured to extrude the first and second materials in a desired order (e.g., the optical coupler 142 will be extruded first and the lens 144 will be extruded next) and form (e.g., the form of the optical coupler shown in FIGS. 3A-3B and 4A-4B, and the form of the lens shown in FIGS. 3A-3B or 4A or 4B). In some implementations, the thicknesses of the optical coupler 142 and the lens 144 are controlled by the relative speeds and sizes of the first and second extruders delivering the first and second materials, respectively. Additionally, the form of the optical coupler and the lens can be controlled by different shapes of respective portions of the extrusion head. A similar or different process for co-extruding two plastics, sometimes also referred to as double extrusion (or, more generally, multiple extrusion) is available from FORMTECH ENTERPRISES, INC. of Stow, Ohio, USA (see www.formtech.com), BWF Profiles—part of BWF Group of Offingen, Germany (see www.bwf-group.de/en/), or SANDEE PLASTICS of Paramount, Calif., USA (see www.sandeeplastics.com).

In the above description, numerous specific details have been set forth in order to provide a thorough understanding of the disclosed technologies. In other instances, well known structures, and processes have not been shown in detail in order to avoid unnecessarily obscuring the disclosed technologies. However, it will be apparent to one of ordinary skill in the art that those specific details disclosed herein need not be used to practice the disclosed technologies and do not represent a limitation on the scope of the disclosed technologies, except as recited in the claims. It is intended that no part of this specification be construed to effect a disavowal of any part of the full scope of the disclosed technologies. Although certain embodiments of the present disclosure have been described, these embodiments likewise are not intended to limit the full scope of the disclosed technologies.

The preceding figures and accompanying description illustrate example systems and devices for illumination. It will be understood that these methods, systems, and devices are for illustration purposes only. Moreover, the described systems/devices may use additional parts, fewer parts, and/or different parts, as long as the systems/devices remain appropriate. In other words, although this disclosure has been described in terms of certain aspects or implementations and generally associated methods, alterations and permutations of these aspects or implementations will be apparent to those skilled in the art. Accordingly, the above description of example implementations does not define or constrain this disclosure. Further implementations are described in the following claims.

What is claimed is:

1. An illumination system comprising:
a housing elongated along a first direction;
a substrate supported inside the housing and extending along the first direction;
a plurality of light emitting diodes (LEDs) distributed along and supported by the substrate inside the housing; and
a co-formed optical element extending along the first direction and comprising
an optical coupler comprising a first material, the optical coupler is optically coupled with the LEDs to receive light emitted by the LEDs and is configured to reflect the emitted light as reflected light with a divergence smaller than a divergence of the emitted light, at least in a cross-section orthogonal to the first direction,
a lens comprising a second material, the second material being different from the first material, the lens being configured and arranged to diffuse the reflected light by transmitting the light through the lens to an ambient environment as output light, wherein the optical coupler and the lens are integrally co-formed as a single piece such that the lens joins seamlessly with the optical coupler, wherein an optical axis of the co-formed optical element is orthogonal to the first direction, and a joint where the optical coupler and the lens join together is in a plane orthogonal to the optical axis, and
attachment elements that cause the co-formed optical element to attach itself inside the housing through friction with the housing caused by compression of the attachment elements.

2. The illumination system of claim 1, wherein the one or more attachment elements are integrally co-formed with the optical coupler.

3. The illumination system of claim 2, wherein the one or more attachment elements comprise the same first material as the optical coupler.

4. The illumination system of claim 1, wherein
the first material from which the optical coupler is formed is a first acrylic, and
the second material from which the lens is formed is a second acrylic.

5. The illumination system of claim 1, wherein a cross-section of side surfaces of the optical coupler in a plane orthogonal to the first direction includes one or more arcs of one or more parabolas, hyperbolas or circles.

6. The illumination system of claim 1, wherein a cross-section of an output surface of the lens is flat.

7. The illumination system of claim 1, wherein a cross-section of an output surface of the lens is convex.

8. The illumination system of claim 1, wherein a cross-section of an output surface of the lens is concave.

9. The illumination system of claim 1, wherein
an opening of the optical coupler forms an opening plane orthogonal to an optical axis of the co-formed optical element, and
a relative arrangement of the substrate to the opening is such that a surface of the substrate that supports the LEDs coincides with the opening plane or is displaced from the opening plane towards the lens.

10. The illumination system of claim 1, comprising a power supply coupled with the LEDs configured to power the LEDs, wherein the power supply is supported inside the housing.

11. The illumination system of claim 1, wherein the LEDs are configured to emit white light.

12. A co-formed optical element for a light fixture, the co-formed optical element comprising:
an optical coupler comprising a first material, the optical coupler configured and arranged to reflect light from a light source; and
a lens comprising a second material, the second material being different from the first material, the lens being configured and arranged to diffuse the light, which is reflected by the optical coupler from the light source, by transmitting the light through the lens;
wherein the optical coupler and the lens are integrally co-formed as a single piece such that the lens joins seamlessly with the optical coupler.

13. The co-formed optical element of claim 12, wherein
the first material from which the optical coupler is formed is a first acrylic, and
the second material from which the lens is formed is a second acrylic.

14. The co-formed optical element of claim 12, wherein the optical coupler and the lens are coextruded materials.

15. The co-formed optical element of claim 12, wherein
the light source comprises a light emitting diode (LED), and
the optical coupler is shaped to reflect the light emitted by the LED as reflected light, such that a divergence of the reflected light is smaller than a divergence of the emitted light.

16. The co-formed optical element of claim 15, wherein a surface of the optical coupler is configured to reflect the emitted light through specular reflection.

17. The co-formed optical element of claim 15, wherein a surface of the optical coupler comprises a microstructure that reflects the emitted light through diffuse reflection.

18. The co-formed optical element of claim 12, wherein an area of a joint where the optical coupler and the lens join together is a fraction of each of an area of either of side surfaces of the optical coupler and an area of an output surface of the lens.

19. The co-formed optical element of claim 18, wherein the co-formed optical element is elongated along a first direction orthogonal to an optical axis of the co-formed optical element.

20. The co-formed optical element of claim 19, wherein a cross-section of side surfaces of the optical coupler in a plane orthogonal to the first direction includes one or more arcs of one or more parabolas, hyperbolas or circles.

21. The co-formed optical element of claim 19, wherein a cross-section of an output surface of the lens is flat.

22. The co-formed optical element of claim 19, wherein a cross-section of an output surface of the lens is convex.

23. The co-formed optical element of claim 19, wherein a cross-section of an output surface of the lens is concave.

24. An illumination device comprising:
the co-formed optical element of claim 19;
a substrate elongated along the first direction; and
a plurality of LEDs distributed along and supported by the substrate,
wherein the optical coupler of the co-formed optical element is optically coupled with the plurality of LEDs, and
during operation of the illumination device, the optical coupler reflects light emitted by the plurality of LEDs as reflected light with a divergence smaller than a divergence of the emitted light, at least in a cross-section orthogonal to the first direction, and the lens transmits the reflected light to an ambient environment as output light.

25. The illumination device of claim 24, wherein
an opening of the optical coupler forms an opening plane orthogonal to the optical axis of the co-formed optical element, and
a relative arrangement of the substrate to the opening is such that the opening plane coincides with a surface of the substrate that supports the LEDs.

26. The illumination device of claim 24, wherein
an opening of the optical coupler forms an opening plane orthogonal to the optical axis of the co-formed optical element, and
a relative arrangement of the substrate to the opening is such that a surface of the substrate that supports the LEDs is displaced from the opening plane towards the lens.

27. The illumination device of claim 24, wherein the LEDs are configured to emit white light.

28. The illumination device of claim 24, wherein the LEDs are packaged LEDs.

29. The illumination device of claim 24, further comprising a power supply configured to provide electrical current to the plurality of LEDs.

30. An illumination system comprising:
the illumination device of claim 24; and
a housing configured and arranged to support the illumination device.

31. The illumination system of claim 30, wherein
the optical element further includes one or more attachment elements that cause the co-formed optical element to attach itself inside the housing, and
the housing comprises a substrate mount configured to support the substrate.

32. The illumination system of claim 31, wherein the co-formed optical element attaches itself to the housing through friction with the housing caused by compression of the attachment elements.

33. The illumination system of claim 31, wherein the one or more attachment elements are integrally co-formed with the optical coupler.

34. The illumination system of claim 31, wherein the one or more attachment elements comprise the same first material as the optical coupler.

35. The illumination system of claim 30, wherein the housing comprises a power supply mount to support the power supply.
